(19) United States
(12) Patent Application Publication
(10) Pub. No.: US 2008/0010591 A1
(43) Pub. Date: Jan. 10, 2008

(54) Web forms creation and reporting tool

(76) Inventors: Frederick L. Good, Cambridge, MA (US); Thuy Tu Pham, Norwood, MA (US); Craig A. Stuber, Brentwood, NH (US)

Correspondence Address: KRAMER & AMADO, P.C., 1725 DUKE STREET, SUITE 240, ALEXANDRIA, VA, 22314, US

(21) Appl. No.: 11/819,831

(22) Filed: Jun. 29, 2007

Related U.S. Application Data
(60) Provisional application No. 60/817,356, filed on Jun. 30, 2006.

(51) Int. Cl. G06F 17/00; G06F 3/048

(52) U.S. Cl. 715/255; 715/764; 715/221; 715/234; 715/243

(57) ABSTRACT

Interface tools, methods and/or computer instructions for building a web page which may be a web form, wherein a user is presented with a user interface providing a layout of the web form. A user interface including a design space allows the user to enter at least one text element for the creation of a web form. A parsing tool translates the text element into an input object for the web page. The web form may be displayed within an Internet browser. A reporting tool creates a report for the display of data captured via the web form.

This application claims priority to Provisional Application Ser. No. 60/817,356 filed on Jun. 30, 2006, the contents of which are incorporated herein in their entirety.

### FIELD OF THE INVENTION

The present invention generally relates to the building of web pages such as web forms. More particularly, the present invention relates to tools and methods for building web forms and reports for web form captured data.

### BACKGROUND OF THE INVENTION

The Internet today includes millions of web sites hosted on servers around the world. Each website consists of various pages, related or not, that are linked together in various manners to other pages within the same site or to other sites. Websites are created for distributing information, advertising, selling or buying goods and services, and expressing ones' creative nature.

Websites include a variety of pages so as to improve communication with the viewer. Websites commonly include pages containing graphic displays for attracting the viewer's attention, simple text pages for quick and effective communication of information, ecommerce pages for the selling of goods and services, web forms and a variety of other pages. Web forms are quite common because they are effective in capturing information. For example, web forms may be used to capture viewer data such as an email address for inclusion in newsletter e-mailings or name/address information for regular mailings. Web forms are also convenient in that viewers may use them to complete a variety of tasks, such as joining particular programs (e.g., a sign up form for a rowing program), modifying previously entered and/or stored data (e.g., address information), and even electronically signing legal and other documents. Furthermore, web forms may be incorporated within a website in a variety of ways, whether as part of a web page or as their own separate page, depending on what best serves the needs of the website operator and/or viewer.

Websites may be created using simple text editing software. This ‘do-it-yourself’ development environment requires the designer to know a plethora of hypertext markup language symbols and techniques that are beyond the skill and interests of an average computer user.

Websites may also be created using more sophisticated web designing tools. This component development environment provides the professional designer with the ability to create complex websites. These websites might require the integration of modules for ecommerce, data entry, web statistics, site security, video, downloads, forms and others. To further complicate matters, the professional must also deal with website support services such as hosting, domain name, bandwidth, storage and email.

These two web designing approaches are mastered through lots of training and skill. These website building tools are geared towards power users and fundamentally fail to guide a user through the simplest of tasks. This lack of guidance not only makes it difficult for the user to create, upload and maintain the simplest text pages, but the creation of more complex pages is simply beyond the capabilities of most users. For example, the creation of a web form can be a complex process, because a web form may serve a variety of functions, and therefore, the creator is faced with numerous creative and technical decisions including, but not limited to, form layout, data input (e.g., text boxes, radio buttons) as well as data capture and storage.

Despite the problems discussed above, little assistance is available to the user when building complex web pages. Some efforts have been made to provide the user with menus of items, so that the user selects each item to be included in a web page. Other efforts have focused on providing the user with a menu of selectable items, wherein each item may be selected by the user and dragged so as to generate a web page. However, such efforts require complex programming before they can be offered to users (e.g., website builders). Due to such complex programming, these efforts often result in an expensive option for users. Furthermore, unless great effort is made in programming these efforts into building tools, website builders may be left with limited creativity and control over the look, feel and function of their web pages.

Accordingly, there is a need for improved tools and methods which allow users to simply and easily build complex pages such as web forms without overwhelming the user with a myriad of complex requirements. There is also a need for improved tools and methods which allow users to build and view reports for data captured via such web forms.

### SUMMARY OF THE INVENTION

According to a preferred embodiment, the present invention generally relates to interface tools for building a web page and/or form, the interface tool comprising: a user interface comprising a design space, the user interface providing for a user to enter at least one text element in the design space; and a parsing tool for translation of the at least one text element into at least one input object for the web page and/or form.

According to another preferred embodiment, the present invention generally relates to methods for building a web page and/or form using an interface tool, the method comprising: providing a user interface comprising a design space; a user entering at least one text element in the design space; and parsing the text element into at least one input object for the web page and/or form.

According to a further preferred embodiment, the present invention generally relates to computer readable storage medium on which is embedded one or more computer programs, the one or more computer programs implementing a method for building a web page and/or form, the one or more computer programs comprising a set of instructions for: providing a user interface comprising a design space, the user interface providing for a user to enter at least one text element in the design space; and providing a parsing tool for translation of the at least one text element into at least one input object for the web page and/or form.

### BRIEF DESCRIPTION OF THE DRAWINGS

Examples of the invention are illustrated, without limitation, in the accompanying figures in which like numeral references refer to like elements, and wherein:

FIG. 1 shows an interface for providing a layout of a web form, in accordance with a preferred embodiment of the present invention.

FIG. 2 shows an interface comprising a design space, in accordance with the preferred embodiment of FIG. 1.

FIG. 3 shows an interface displaying a text element in the design space, in accordance with the preferred embodiment of FIGS. 1 and 2.

FIG. 4 shows an interface for display of an input object, in accordance with the preferred embodiment of FIGS. 1, 2 and 3.

FIG. 5 shows an interface for providing a layout of a web form, in accordance with another preferred embodiment of the present invention.

FIG. 6 shows an interface displaying a text element in the design space, in accordance with the preferred embodiment of FIG. 5.

FIG. 7 shows an interface for display of an input object, in accordance with the preferred embodiment of FIGS. 5 and 6.

FIG. 8 shows an interface for providing a layout of a web form, in accordance with another preferred embodiment of the present invention.

FIG. 9 shows an interface displaying a text element in the design space, in accordance with the preferred embodiment of FIG. 8.

FIG. 10 shows an interface for display of an input object, in accordance with the preferred embodiment of FIGS. 8 and 9.

FIG. 11 shows a web view of a built web form, in accordance with the preferred embodiment of FIGS. 8, 9 and 10.

FIG. 12 shows a report for displaying data captured via a web form built in accordance with a preferred embodiment of the present invention.

FIG. 13 shows a technical design, in accordance with a preferred embodiment of the present invention.

FIG. 14 shows a form library, in accordance with a preferred embodiment of the present invention.

FIG. 15 shows a parsing tool, in accordance with a preferred embodiment of the present invention.

FIG. 16 shows a block diagram of a computer system wherein preferred embodiments of the present invention may be implemented.

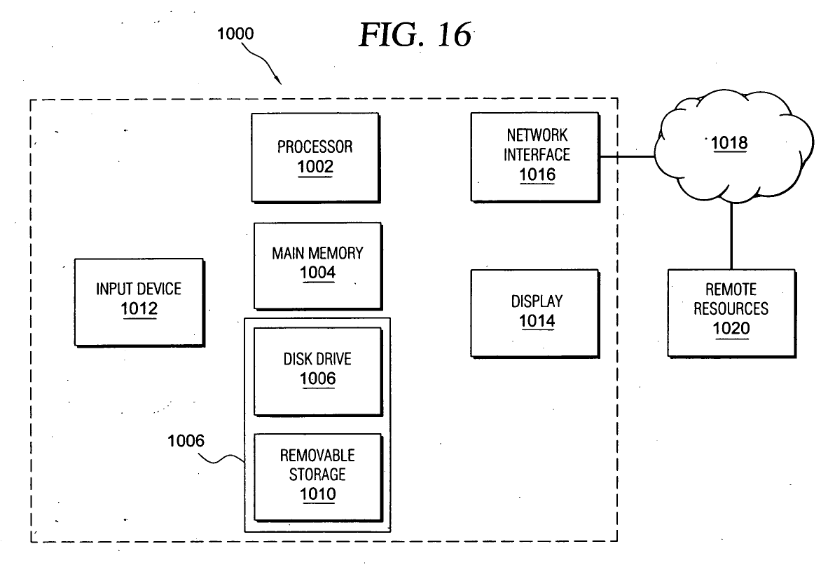

### DETAILED DESCRIPTION OF THE PREFERRED EMBODIMENTS

For simplicity and illustrative purposes, the principles are shown by way of examples of systems and methods described. In the following description, numerous specific details are set forth in order to provide a thorough understanding of the examples. It will be apparent however, to one of ordinary skill in the art, that the examples may be practiced without limitation to these specific details. In other instances, well known methods and structures are not described in detail so as not to unnecessarily obscure understanding of the examples.

The present invention relates to user interface tools, methods and computer programs for creating web pages (e.g., web forms). The interface tools, methods and computer programs of the present invention provide the user with at least one interface 100 through which the layout 110 and design of the web page 400 may be selected or created by the user. The interface tools, methods and computer programs of the present invention allow a user to create a web page 400 via simple text elements 200, preferably the entering of text elements 200 in a design space 510 accessible through a user interface 100. The interface tools, methods and computer programs of the present invention also provide a parsing tool for the translation of text elements 200 into input objects 300 for a web page 400. Those of ordinary skill in the art will recognize that through the use of simple text elements 200 and their parsing into input objects 300, the interface tools, methods and computer programs of the present invention provide the user with an improved and simplified technique with which to create and build complex web pages such as web forms 400.

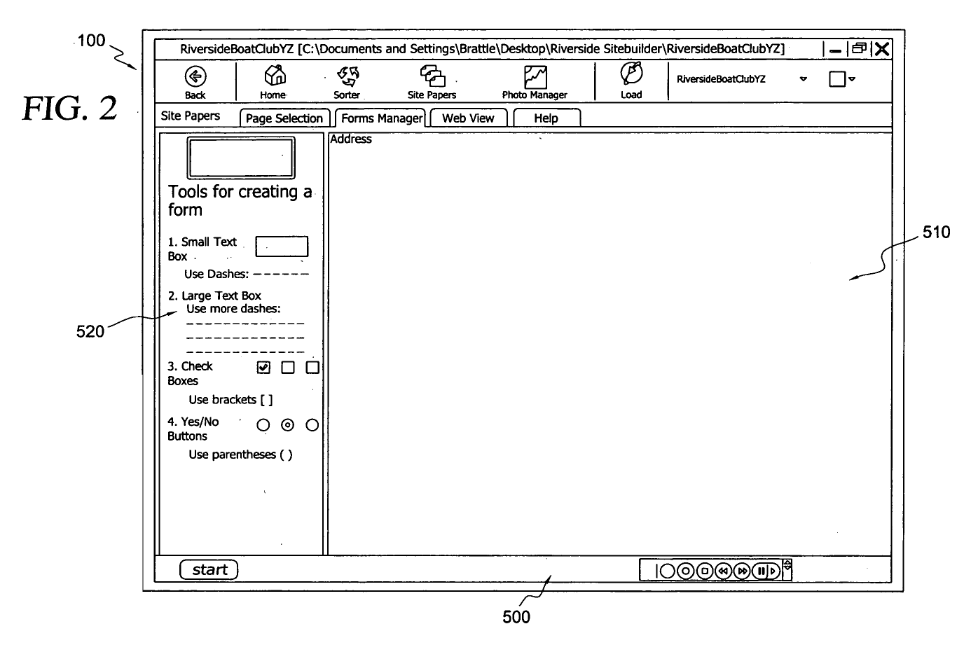

Throughout the present disclosure, reference is made to text elements 200. A text element 200 is any standard text character that may be entered by the user and translated by a parser in accordance with the present invention. Preferably, the standard text character is translated into an input object 300 in accordance with the present invention. Put another way, in a preferred embodiment, the standard text character serves as a representation of an input object 300, wherein the standard text character may be parsed or translated into the input object 300. In one example, the text element 200 comprises dashes 210, 220, as shown in FIGS. 2, 3, 6 and 9, wherein the dashes 210, 220 represent and are parsed into a text box 310, 320 (input object) for a web form 400. In another example, the text element 200 comprises brackets 230, as shown in FIGS. 2, 3, 6 and 9, wherein brackets 230 represent and are translated into a check box 330 (input object) for a web form 400. In another example, the text element 200 comprises parentheses 240, as shown in FIGS. 2, 3, 6 and 9, wherein the parentheses 240 represent and are translated into yes/no buttons 340 (input object) for a web form 400.

Throughout the present disclosure, reference is made to a parsing tool (or parser). A parsing tool may be any application (e.g., computer program or instructions) that translates a text element 200 into an input object 300. Preferably, the parsing tool translates a text element 200 into an input object 300, wherein the input object 300 is then included as part of a web form 400. In one example, the parsing tool comprises software instructions for translating a text element 200 into an input object 300, preferably as part of a web form 400.

Throughout the present disclosure, reference is made to an input object 300. An input object 300 is any means which allows a viewer or user of a page to input data and/or information. An input object 300 may also be referred to as an input field, for example a text box or field 310, 320, check box 330, yes/no buttons 340 or drop-down box (not shown). Preferably, the input object 300 is included as part of a web form 400 which may be published, for example in an Internet browser. In one example, the input object 300 is a text box 310, 320 for a web form 400. In another example, the input object 300 is a check box 330 for a web form 400. In another example, the input object 300 is yes/no buttons 340 for a web form 400.

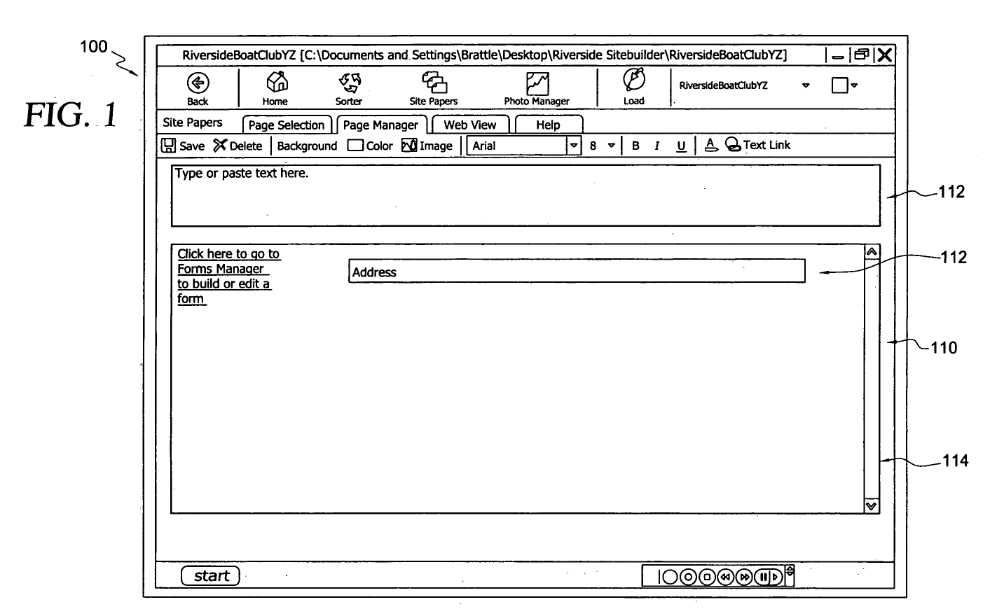

Throughout the present disclosure, reference is made to an interface (or user interface) 100. An interface 100 is a tool through which the user may interact with any element(s) of the present invention. Preferably, the interface 100 is a screen displayed within a computer application or web browser for interaction with elements of the present invention. In one example, the interface 100 is a screen through which the user may select or create a layout 110 for a web form 400, as illustrated in FIGS. 1, 5 and 8. In another example, the interface 100 is a screen through which the user may enter a text element 200, as illustrated in FIGS. 2, 3, 6 and 9. Those of ordinary skill in the art will recognize that an interface may be embodied by a computer program or a plurality of computer programs, which may exist in a variety of forms both active and inactive in a single computer system or across multiple computer systems.

Those of ordinary skill in the art will recognize that the present invention generally relates to improved tools, methods and computer software programs for building a web page, in particular a web form 400. In the present invention, the user (e.g., website or web form builder) with limited knowledge of web design may create the input objects or fields 300 that make up a web form 400 or parts of a web page. The user is provided with the tools to create the input objects 300 through the use of text elements 200. As discussed above, a text element 200 may be translated by a parsing tool into an input object 300 and preferably displayed as part of a web form 400. Preferably, the user creates a web form 400 by entering a text element(s) 200 within the design space 510 accessed through a user interface 100, wherein a parsing tool translates the text elements 200 into input objects 300 as part of a web form 400.

In one example, the present invention includes text elements 200, thereby allowing users to quickly and simply create complex web pages including web forms 400. Previously, such text elements 200 were not available to users for the creation of web pages and, as a result, it was necessary to for users to learn and utilize complex skills and tools when creating web pages such as web forms 400. In accordance with preferred embodiments of the present invention, however, users are now able create forms 400 with simple text elements 200. Rather than having to learn complex skills, the simplicity of text elements 200 allows the user to create web pages with little more than a user interface 100 and limited instruction, for instance as shown in FIGS. 2, 3, 6 and 9.

In another example, the present invention also includes a parsing tool, which may be used to translate (or parse) the text elements 200 into input objects 300. Preferably, the parsing tool is comprised of software instructions, so that the user need not learn how to use or even be aware of the parsing tool. The parsing tool may be embodied within the various examples of the present invention. Preferably, the parsing tool automatically converts text elements 200 to input objects 300 as the user employs the interface 100 tools and methods of the present invention. Put another way, the translation function of the parsing tool may be automatically activated as the user navigates the interface 100 tools and methods of the present invention. A preferred embodiment of the parsing tool is described in detail below.

In one preferred embodiment, discussed with reference to FIGS. 1-4, the present invention encompasses a tool, method and/or computer programs through which the user may build a web form 400. For example, as illustrated in FIG. 1, the user accesses an interface 100 executed for instance within a computer application or an Internet browser (e.g., Internet Explorer). In one example, the interface 100 allows the user to create a “custom” layout 110 for a web form 400. That is, in accordance with preferred embodiments of the present invention, the user may be provided with a blank layout 110 along with the means for locating the web form and/or or elements of the web form within the layout 110 wherever the user so chooses. Those of ordinary skill in the art will recognize that the user may be provided with a variety of means for customizing a layout 110, such as a control tool located within a tool bar. Those of ordinary skill in the art will also recognize that a control tool may be in the form of various preferred embodiments, for instance a drawing tool or a select-and-drag tool which allows the user with the option of providing the elements of a web form 400 within a layout 110 in a “custom” configuration.

In another example, the interface 100 includes at least one prescribed layout 110 for a web form 400, wherein the user may select a layout 110 from those provided. As illustrated in FIG. 1, an example prescribed layout 110 includes a smaller, upper text box 112 and a larger, lower forms box 114. Within the upper text box 112, the user may enter (e.g., type or paste) text. In this example, the lower forms box 114 also includes a text box 112 in which the user enters (e.g., types or pastes) text. The lower forms box 114 preferably allows the user to begin building a web form 400. For example, in this example, the lower forms box 114 allows the user to access the Forms Manager 500, in this instance via a text link (“Click here to go to Forms Manager to build or add a form”), wherein the user may build the web form 400.

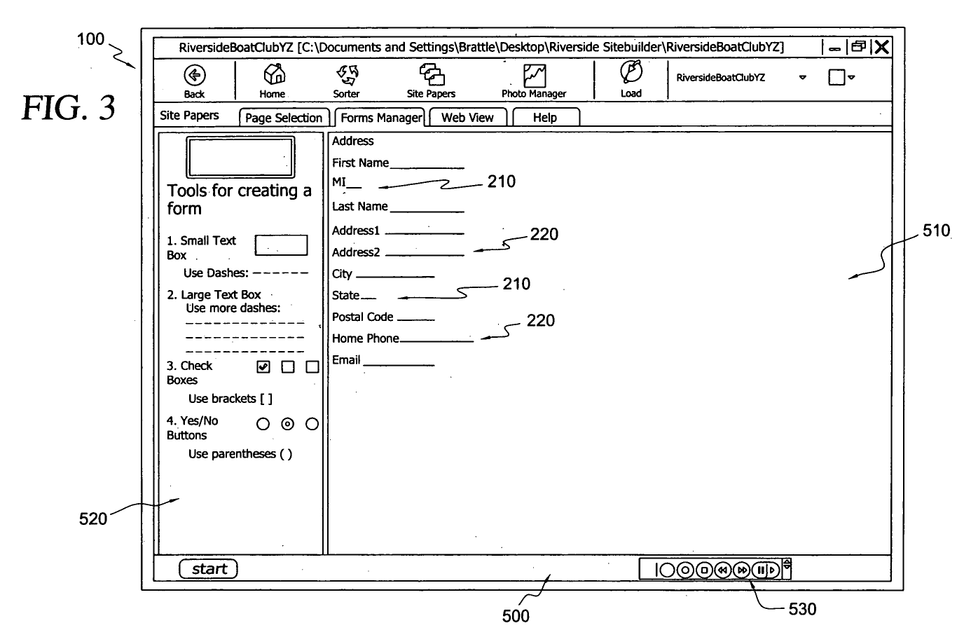

As illustrated in FIGS. 2 and 3, an interface 100 provides the user with access to the Forms Manager 500. The Forms Manager 500 preferably enables the use of at least one text element 200 which may be used to produce an input object 300 for a web form 400. The Forms Manager 500 preferably includes a design space 510 for the building of the web form 400 with text elements 200. Preferably, the Forms Manager 500 includes an instruction space (e.g., containing written instructions) 520 directing the user in the creation of a web form 400 with text elements 200. In one example, as illustrated in FIGS. 2 and 3, the instructions space 520 may inform that user that text element 200 of dashes, ------ 210, may be entered by the user in the design space 510 for creating a small text box 310 (input object). The instructions may also inform the user that a larger text box 320 (input object) may be created by entering a larger number of dashes, --------------- 220. The instructions 520 may also inform the user that a check box 330 (input object) may be created by entering the text element 200 of brackets 230, [ ], in the design space 510. The instructions 520 may further inform the user that yes/no buttons 340 (input object) may created by the user entering the text element 200 of parentheses 240, ( ), in the design space 510. Those of ordinary skill in the art will recognize that a variety of different text elements 200 and instructions 520 associated therewith may be included as part of the Forms Manager 500, for instance as illustrated in FIGS. 2 and 3.

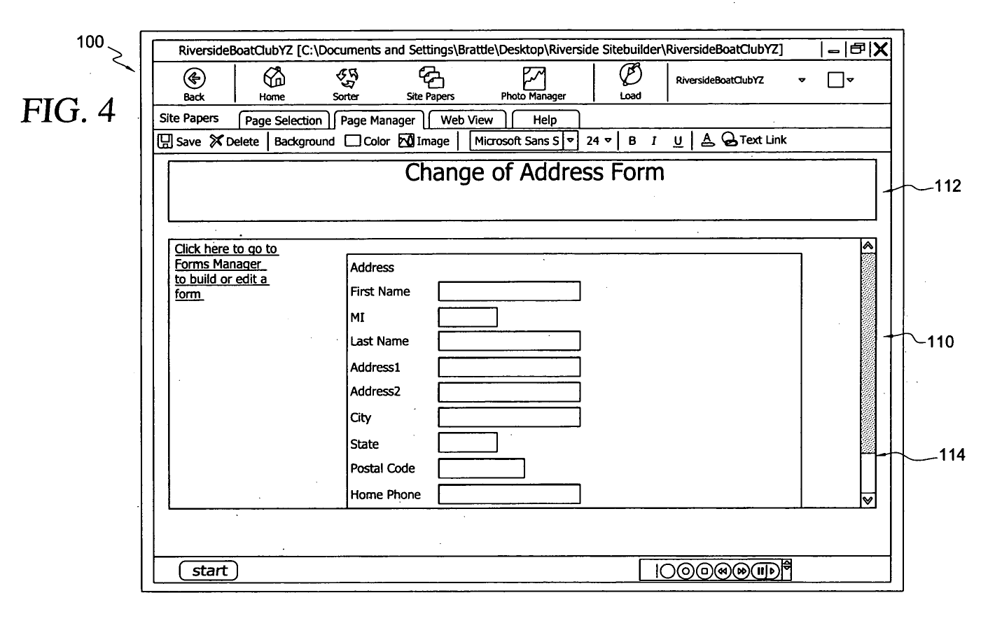

FIG. 3 further illustrates use of the text elements 200 within the design space 510 for creation of a web form 400 within the Forms Manager 500. As shown in FIG. 3, within the design space 510, the user has entered the text element of dashes 210, 220 to represent a text box 310, 320 (input object). As shown in FIG. 3, the user may vary the number of dashes 210, 220 so as to represent text boxes 310, 320 (input objects) of varying length. Those of ordinary skill in the art will recognize that by referring to a user entering a text element 200, it is meant that the user types, pastes or otherwise inserts a text element 200 within the design space 510, in accordance with the improved and simplified aspects of the present invention. Although not illustrated in FIG. 3, if so desired, the user may enter additional text elements 200 (e.g., brackets, parentheses) within the design space 510, for the creation of additional input objects 300 as part of the web form 400. As further illustrated by FIG. 3, the user is preferably provided with a save tool 530, so that this text element 200 representation of the web form 400, which may be referred to as a “draft” form, may be saved for further editing and so on. The user may also be provided with the option of placing the “draft” form within the forms box 114 of the layout 110 previously illustrated in FIG. 1, as is shown in FIG. 4.

As illustrated in FIG. 4, a user interface provides the user with the layout 110 including the upper, text box 112 and lower, forms box 114 as previously shown in FIG. 1. Those of ordinary skill in the art will recognize that the “draft” form of FIG. 3 has been placed within the lower, forms box 114. That is, those of ordinary skill in the art will recognize that the text elements 210, 220 shown in FIGS. 2 and 3 have been translated into the input objects 310, 320 of FIG. 4. A more detailed discussion of the parser for such translation is presented below. In this example, the lower, forms box 114 provides the user with the option of returning to the Forms Manager 500, via the text link (“Click here to go to Forms Manager to build or edit a form”), wherein the user may build another form or edit the current form. Furthermore, in this instance, the user has typed the phrase “Change of Address Form” within the upper, text box 112, thereby providing a title for this web form 400. Preferably, the user interface 100 also provides the user with a Web View of the created work. In other words, the interface 100 preferably provides a view of the web form 400 as it will appear once published to the Internet (i.e., the web). Furthermore, preferably the user is provided with the tools and/or methods to publish the created web form 400 to the Internet, preferably within an Internet browser.

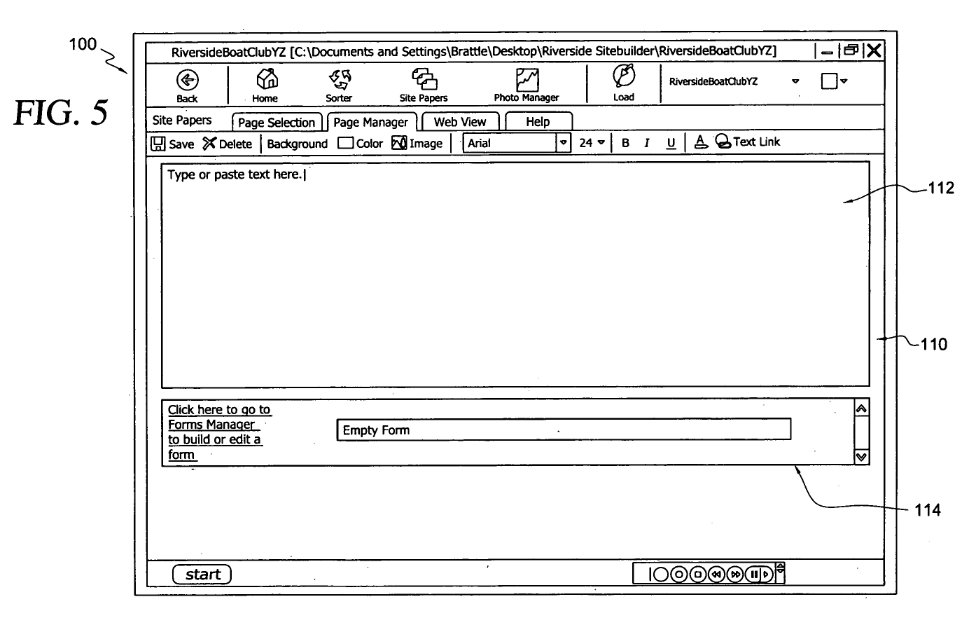

In another preferred embodiment, discussed with reference to FIGS. 5-7, the present invention encompasses a tool, method and/or computer programs through which the user may build a web form. As illustrated in FIG. 5, the user may access an interface 100 executed for instance within a computer application or an Internet browser. In one example, the selects a layout 110 for the web form 400 from a plurality of prescribed web form layouts 110. In another example, the use may create a custom layout 110 for the web form 400. As illustrated in FIG. 5, the prescribed layout includes a large, upper text box 112 and a small, lower forms box 114. Whereas the user may enter (e.g., type or paste) text within the upper text box 112, the lower forms box 114 preferably allows the user to begin building the web form 400. For example, the lower forms box 114 preferably allows the user to access the Forms Manager 500, in this instance via a text link (“Click here to go to Forms Manager to build or edit a form”), wherein the user may build or edit the web form 400.

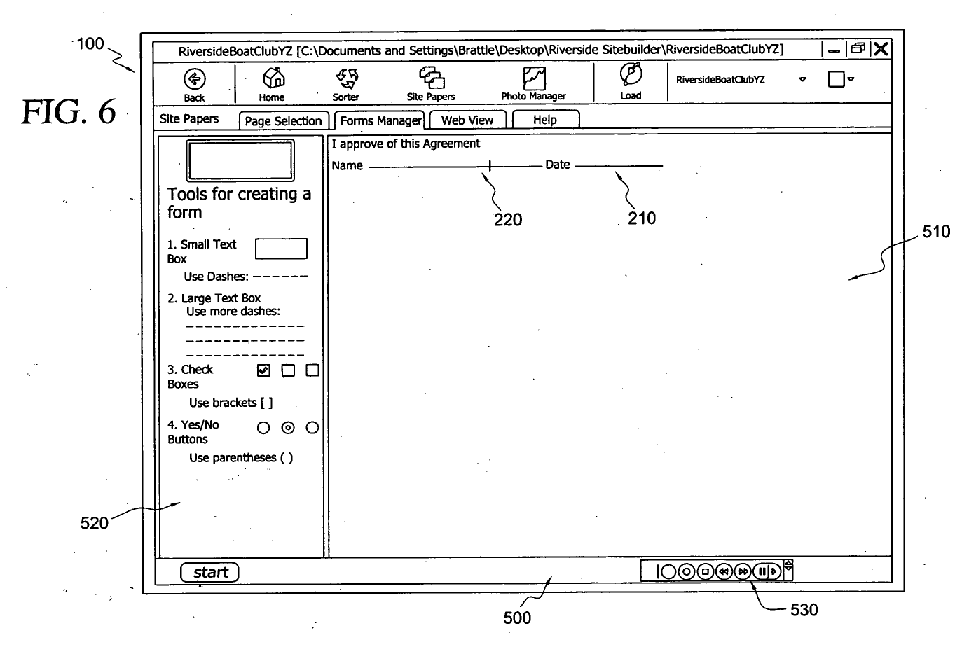

As illustrated in FIG. 6, an interface 100 provides the user with access to the Forms Manager 500. The Forms Manager 500 preferably enables the use of at least one text element 200 which may be entered into the design space 510 in order to create an input object 300. Preferably, the Forms Manager 500 includes an instruction area 520 for instructing the user in the building of the web form 400 with text elements 200. As illustrated by the example of FIG. 6, the instructions may inform the user that the text element of dashes 210, ------, may be entered in the design space 510 for creation of a small text box 310 (input object). The instructions may inform the user that a larger text box 320 may be created by entering a larger number of dashes 220. Although not shown in FIG. 6, the instructions may also inform the user that a check box 330 may be created by entering the text element of brackets 230, [ ], in the design space 510. The instructions may further inform the user that yes/no buttons 340 (input object) may created by entering the text element of parentheses 240, ( ), in the design space 510. Those of ordinary skill in the art will recognize that a variety of different text elements 200 and instructions associated therewith may be included as part of the Forms Manager 500 of FIG. 6.

FIG. 6 also illustrates use of text elements 200 for creation of the web form 400. As shown in FIG. 6, through the combination of text and text elements 210, 220 (dashes) entered within the design space 510, the user has created a representation of a web form 400 including a signature and date area for a legal or other document. Those of ordinary skill in the art will recognize that the user may enter additional text elements 200 (e.g., brackets 230, parentheses 240) within the design space 510, for the creation of additional input objects 300 as part of the web form 400. As further illustrated by FIG. 6, the user is preferably provided with a save tool 530, so that this text element 200 representation of the web form 400, which may be referred to as a “draft” form, may be saved for further editing and so on. The user may also be provided with the option of placing the “draft” form within the forms box 114 of the layout 110 previously illustrated in FIG. 5.

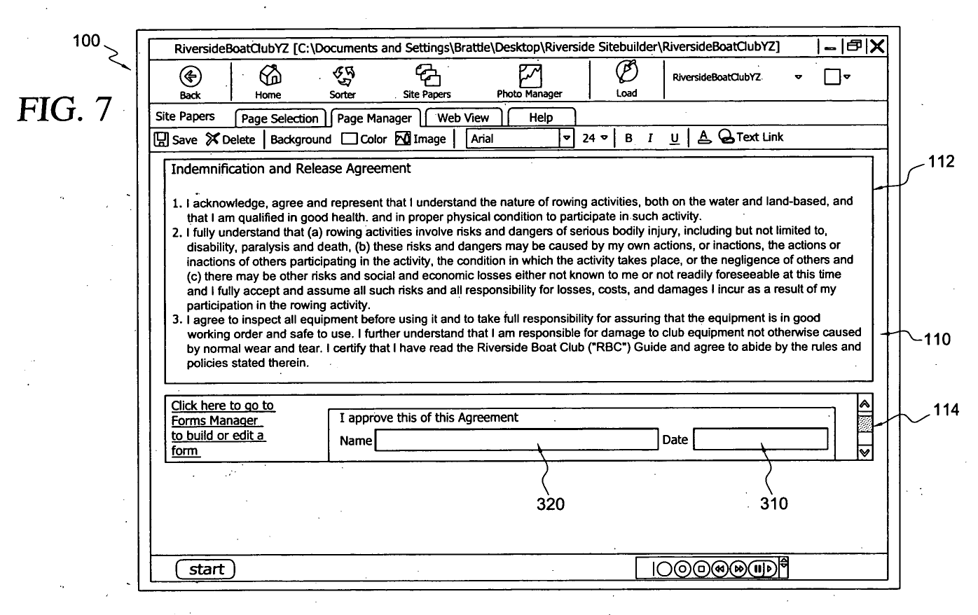

As illustrated in FIG. 7, a user interface 110 provides the user with the layout 110 including the upper, text box 112 and lower, forms box 114 as previously shown in FIG. 5. Those of ordinary skill in the art will recognize that the “draft” form of FIG. 6 has been placed within the lower, forms box 114. That is, those of ordinary skill in the art will recognize that the text elements 210, 220 shown in FIG. 6 have been translated into the input objects 310, 320 of FIG. 7. That is, the text elements 210, 220 representing signature and date text boxes have been translated into text boxes 310, 320 for entering the signature (and date) of a visitor to the web form 400. A more detailed discussion of the parser for such translation is presented below. In this example, the lower forms box 114 also includes a text link (“Click here to go to Forms Manager to build or edit a form”), allowing the user to return to the Forms Manager 500 of FIG. 6, where the user may build another form or edit the current form. Moreover, in this example, the user has included the text of a legal agreement (“Indemnification and Release Agreement”) within the upper text box 112.

Those of ordinary skill in the art will further recognize that the user interface 100, such as shown in FIG. 7, preferably also provides the user with a Web View of the created web form 400; that is, the interface preferably provides a view of the web form 400 as it will appear once published to the Internet (i.e., the web). Furthermore, preferably the user is provided with the tools and/or methods to publish the created web form 400 to the Internet, preferably within an Internet browser. In the example of FIG. 7, those of ordinary skill in the art will recognize that once the web form is published to the Internet, the text of the legal agreement will display above the signature and date input fields 310, 320.

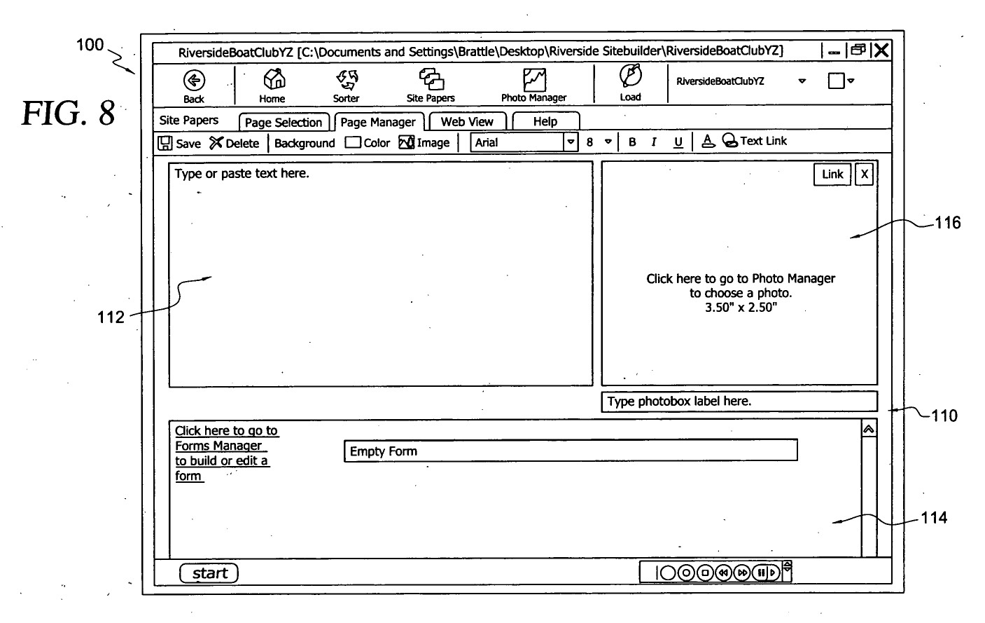

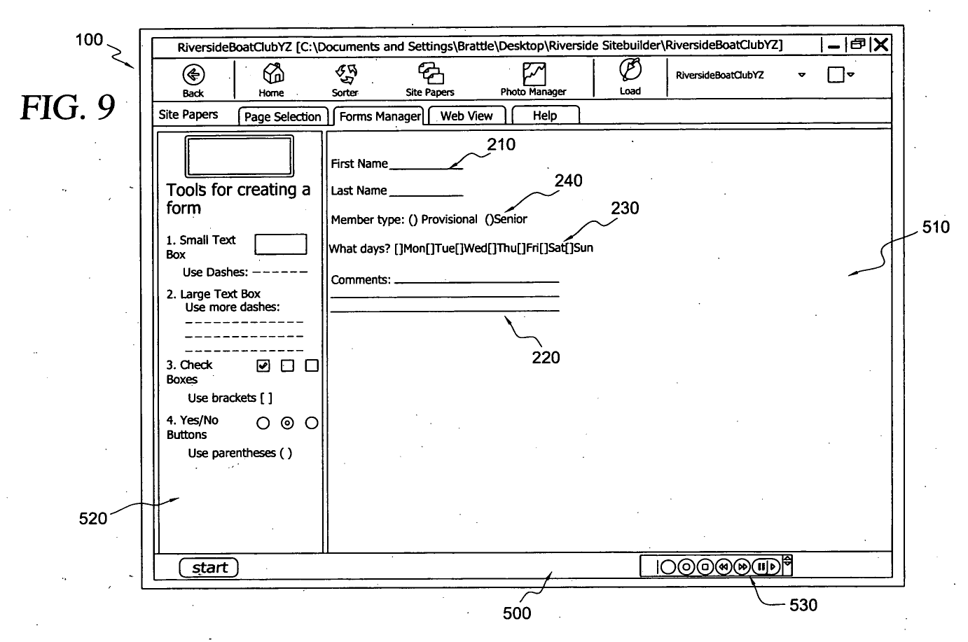

In another preferred embodiment, discussed with reference to FIGS. 8-11, the present invention encompasses a tool, method and/or computer programs through which the user may build a web form 400. As illustrated in the example of FIG. 8, via a user interface 100, the user selects a layout 110 for a web form 400 from a plurality of prescribed web form layouts 110. In another example, the user may create a custom layout 110 for the web form 400. As shown in FIG. 8, the prescribed layout 110 may include an upper left, text box 112, an upper right, photo box 116 and a lower forms box 114. The user may preferably enter text within the text box 112, insert a photo(s) (not shown) within the photo box 116, as well as begin building a web form 400 through the lower forms box 114. For instance, in this example, the lower forms box 114 allows the user to access the Forms Manager 500 via a text link (“Click here to go to Forms Manager to build or edit a form”), wherein the user may build or edit the web form 400, for instance as illustrated in FIG. 9.

As illustrated in FIG. 9, an interface 110 provides the user access to the Forms Manager 500. The Forms Manager 500 preferably enables the use of at least one text element 200 which may be entered by the user within the design space 510 in order to create an input object 300. Preferably, the Forms Manager 500 also includes an instructions area for directing the user in the use of text elements 200 for creating a web form 400. As shown in the example of FIG. 9, the instructions may inform the user that text element of dashes 210, 220 may be entered in the design space 510 for creation of a text box 310, 320. The instructions may also inform the user varying the number of dashes 210, 220 may vary the length of a text box 310, 320. The instructions may also inform the user that a check box 330 (input object) may be created by entering the text element of brackets 230 in the design space 510. The instructions may further inform the user that yes/no buttons 340 (input object) may created by entering the text element of parentheses 240 in the design space 510. Those of ordinary skill in the art will recognize that a variety of text elements 200 and instructions associated therewith may be included within the Forms Manager 500.

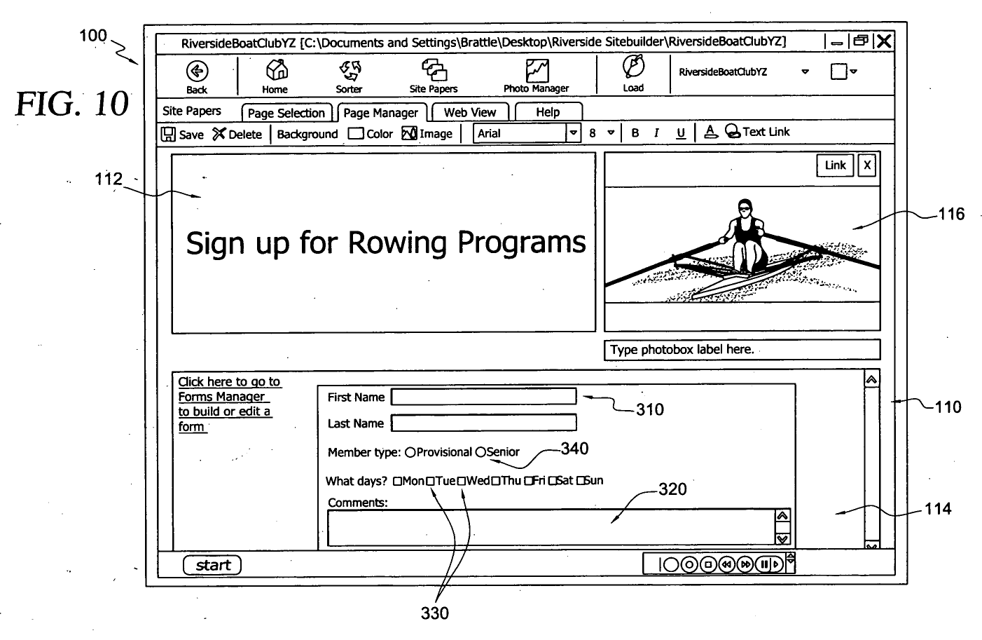

FIG. 9 further illustrates use of the text elements 200 within the design space for the building of a web form 400. As shown in FIG. 9, by entering text and the text elements of dashes, 210, 220, brackets 230 and parentheses 240 within the design space 510, the user has created a representation of a web form 400 which will eventually include the input objects of text boxes 310, 320, check boxes 330 and yes/no buttons 340, respectively. By entering text, the user may also provide labels for each of the input objects, in particular labels concerning a website visitor's First Name, Last Name, Member type, Days? and comments, as shown in both FIGS. 9 and 10. As further illustrated by FIG. 9, the user is preferably provided with a save tool 530 which allows the user the option of saving this representation of a web form, which is referred to as a “draft” form. The user is also preferably provided with the option of placing the “draft” form within the forms box 114 of the layout 110 previously illustrated in FIG. 8.

As illustrated in FIG. 10, the user interface provides the user with the layout 110 including the text box 112, forms box 114 and photo box 116 as previously shown in FIG. 8. Those of ordinary skill in the art will recognize that the “draft” form of FIG. 9 has been placed within the forms box 114. As will also be recognized by those of ordinary skill in the art, the text elements within the design space of FIG. 9 have been translated into the input objects of FIG. 10. That is, the text elements 210, 220, 230, 240 shown in FIG. 9 have been parsed into the input objects 310, 320, 330, 340 and placed within the lower forms box 114. Those of ordinary skill in the art will recognize that the parser has also attended to the spacing between the text and input objects 310, 320, 330, 340. In this example, the user has also entered text (“Sign Up for Rowing Programs”) within the text box 112 and inserted a photo within the photo box 116. Furthermore, the forms box 114 includes a text link (“Click here to go to Forms Manager to build or edit a form”), allowing the user to return to the Forms Manager 500 of FIG. 9 and build another form or edit the current form.

Furthermore, reviewing FIG. 10, those of ordinary skill in the art will recognize that the user interface 100 preferably provides the user with what is known in the art as What You See Is What You Get (“WYSWYG”). That is, the interface 100 (e.g., the Page Manger of the interface 110) preferably provides the user with a view of the page as it will appear when finished and/or published, while the page is still under construction. In other words, in accordance with preferred embodiments of the present invention, the user is preferably provided with a view of the finished and/or published page, as shown for instance in FIG. 10, without the need for additional steps such as publication which are typically required. Those of ordinary skill in the art will recognize that such WYSWYG capability greatly simplifies the process of a building a page, including a web page (e.g., a web forms 400).

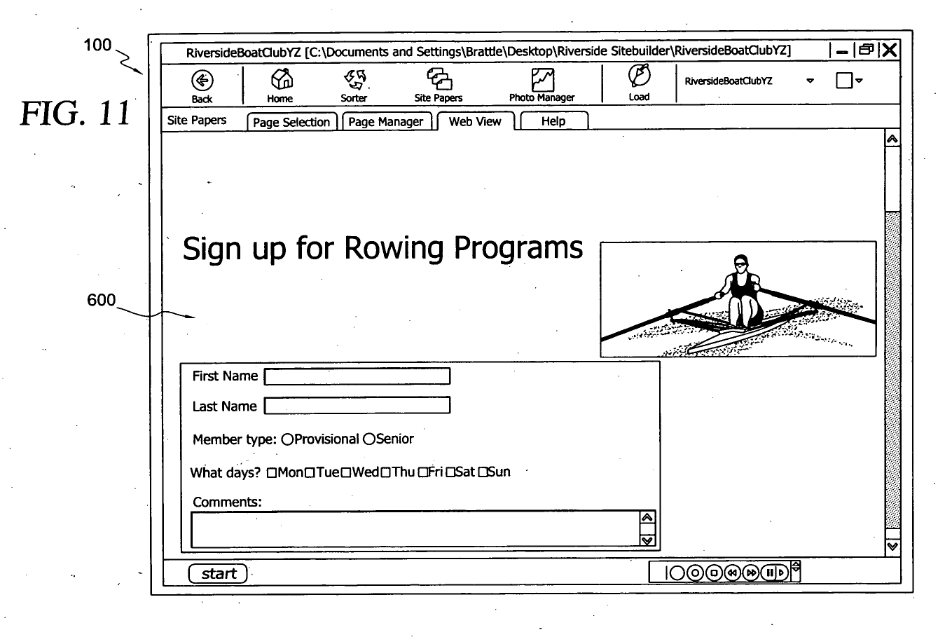

As illustrated in FIG. 11, a user interface 100 preferably provides the user with a Web View 600 of the created web form 400; that is, the interface preferably provides a view of the web form 400 as it will appear once published to the Internet (i.e., the web). The Web View preferably provides its view prior to publication of the web form 400 to the Internet. Furthermore, preferably the user is provided with the tools and/or methods to publish the created web form 400 to the Internet, preferably within an Internet browser.

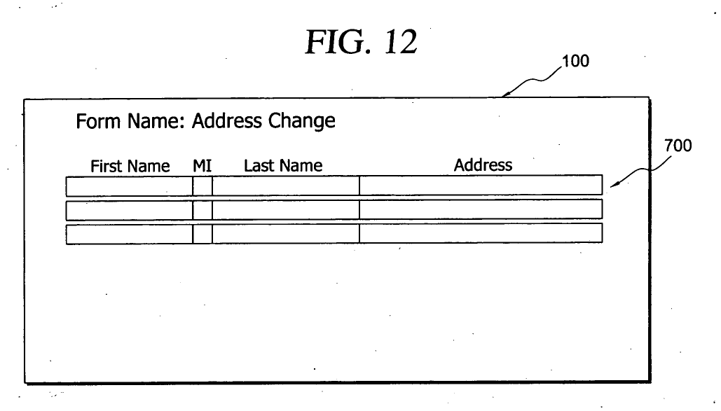

With reference to FIG. 12, those of ordinary skill in the art will recognize that in another preferred embodiment, the present invention includes a reporting tool. In one example, the reporting tool functions to create at least one report 700 which preferably displays data captured by the input object(s) 300 created by the user with text elements 200, for instance web forms 400 including such input object(s) 300 as created within the scope of the present invention. Viewed another way, the reporting tools may create reports 700 displaying the data entered into the input objects 300 by visitors to the web form 400. In the example report 700 of FIG. 12, one of ordinary skill in the art will recognize the report 700 as displaying the first name, middle initial (MI), last name and address entered into input objects 300 of a web form 400, for instance the web form 400 shown in FIGS. 1-4.

Technical Design Overview

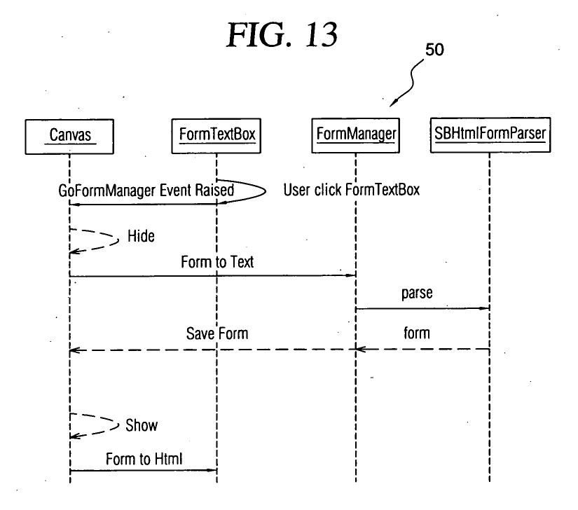

With respect to the technical design, the interface tools, methods and/or computer programs of the present invention may employ any number of preferred embodiments. For example, those of ordinary skill in the art will recognize FIG. 13 as illustrating a technical design 50 in accordance with exemplary embodiments of the present invention.

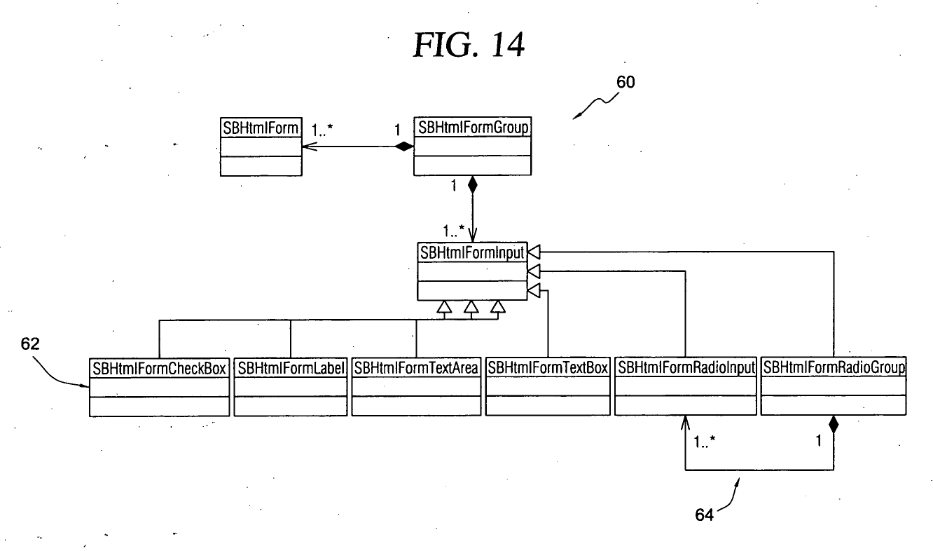

Those of ordinary skill in the art will also recognize FIG. 14 as illustrating a form group in accordance with exemplary embodiments of the present invention. Those of ordinary skill in the art will also recognize that in accordance with exemplary embodiments, the interface tools, methods and/or compute programs of the present invention include a form library 60 that encapsulates at least one web (e.g., HTML) form 400 and its layout 110. The form library 60 preferably provides the web form(s) 400 and layout(s) 110 selected by the user when building a web form 400 in accordance with the preferred embodiments of the present invention. With reference to FIG. 14, those of ordinary skill in the art will recognize that the form inputs 62 in the same form are grouped horizontally. Similarly, a radio group 64 represents radio inputs aligned horizontally. Those of ordinary skill in the art will recognize, however, that the form library 60 and groups may occur in a variety of configurations.

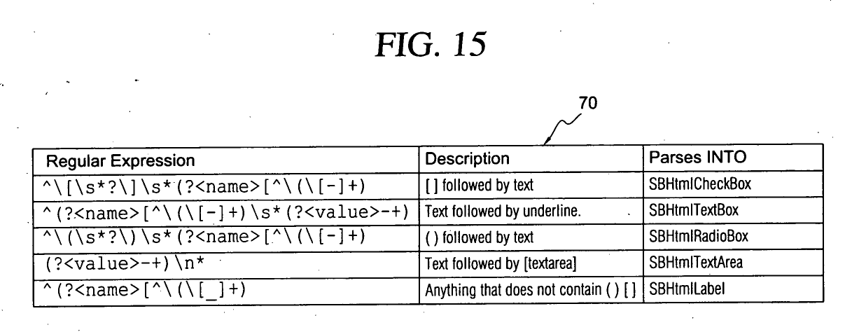

In accordance with preferred embodiments, the interface tools, methods and/or computer programs of the present invention include a parsing tool or parser. As discussed above, the parsing tool is a tool that translates a text element 200 into an input object 300. The parsing tool is preferably a software application, more preferably computer instructions. Preferably, the parsing tool translates text elements 200 into classes within the form library 60. In one example, the parsing tool utilizes a set of regular expressions to parse the text element 200. The table 70 of FIG. 15 illustrates such regular expressions in accordance with the exemplary embodiments of the present invention, as will be recognized by those of ordinary skill in the art. Those of ordinary skill in the art will also recognize that for each text line, the method parseLine is called, for example:

private void parseLine(int groupId, string line, SBHtmlForm form)
{

SBHtmlFormGroup group = new SBHtmlFormGroup(form, groupId);
SBHtmlFormRadioGroup radioGroup = null;
SBHtmlFormGroup prevGroup = form.GetAt(form.Count);
string label;
Match m, ml;
int index, id = l;
int groupLevel = l;
while (line.Length > 0)
{

line = line.TrimEnd(‘ ’);
line = line.TrimEnd(‘\n’);
line = line.TrimEnd(‘\r’);
// check for textbox
#region TextBox RegEx

m = _textboxRegEx.Match(line);
if (m.Success)
{

SBHtmlFormTextBox textBox = handleTextBoxEntry(id++, m);
group.addFormInput(textBox);
index = m.Index + m.Length;
line = line.Substring(index, line.Length − index);
continue;

}
#endregion
#region CheckBox RegEx
m = _checkboxRegEx.Match(line);
if (m.Success)
{

label = m.Groups[“name”].Value;
label = Regex.Replace(label, @“\s”, “”);
if (label.Length > 0)
{

SBHtmlFormCheckBox checkBox = handleCheckboxEntry(id++,

m);

group.addFormInput(checkBox);
index = m.Index + m.Length;
line = line.Substring(index, line.Length − index);
continue;

}

}
#endregion
#region RadioButton RegEx
m = radioRegEx.Match(line);
if (m.Success)
{

label = m.Groups[“name”].Value;
label = Regex. Replace(label, @“\s”, “”);
if (label.Length > 0)
{

if (radioGroup == null)
{

// check if there exists a previous radio group
if (prevGroup != null)
{

SBHtmlFormInput input =

prevGroup.GetAt(prevGroup.Count);

if ((input != null) && (input.InputType ==

FormInput.RadioGroup))

{

radioGroup = (SBHtmlFormRadioGroup) input;
groupLevel = radioGroup.Levels + 1;

}
else
{

radioGroup = new SBHtmlFormRadioGroup(id++,

“”);

group.addFormInput(radioGroup);

}

}
else
{

radioGroup = new SBHtmlFormRadioGroup(id++, “”);
group.addFormInput(radioGroup);
}

}
SBHtmlFormRadioInput radioInput =

handleRadioInputEntry(radioGroup.Count + 1, radioGroup.Id, groupLevel, m);

radioGroup.addRadioInput(radioInput);
index = m.Index + m.Length;
line = line.Substring(index, line.Length − index);
continue;

}

}
#endregion
#region TextArea RegEx
m = _textareaRegEx.Match(line);
if (m.Success)
{

label = line.Substring(m.Length, line.Length − m.Length);
m1 = Regex.Match(label, @“[\hat{ }-\f\n\r\t\v)”,

RegexOptions.None);

if (!m1.Success)
{

SBHtmlFormTextArea txtAreaBox =

handleTextAreaEntry(id++, m, line);

group.addFormInput(txtAreaBox);
if (prevGroup.Count == 1)
{

SBHtmlFormInput lastInput = prevGroup.Last ( );
if (lastInput is SBHtmlFormTextBox)
{

form.RemoveAt(form.Count);
txtAreaBox.Text = lastInput.Text;
txtAreaBox.Row = txtAreaBox.Row + 1;

}
else if (prevGroup.onlyText)
{

form.RemoveAt(form.Count);
txtAreaBox.Text = prevGroup.GetAt(1).Text;

}

}
line = “”;
break;

}

}
#endregion
#region Label RegEx
m = _labelRegEx.Match(line);
if (m.Success)
{

SBHtmlFormLabel text;
if ((group.Count > 0) && (group.GetAt(1).InputType ==

FormInput.Label))

{

text = (SBHtmlFormLabel)group.GetAt(1);
text.Text = text.Text + ‘ ’ + getMatchName(m);

}
else
{

text = handleLabelEntry(id++, m);
group.addFormInput(text);

}
index = m.Index + m.Length;
line = line.Substring(index, line.Length − index);
continue;

}
#endregion
break;

}
if (line.Length > 0)
{

SBHtmlFormLabel text2;
if ((group.Count > 0) && (group.GetAt(1).InputType ==

FormInput.Label))

{

text2 = (SBHtmlFormLabel)group.GetAt(1);
text2.Text = text2.Text + ‘ ’ + line;

}
else
{

text2 = handleLabelEntry(id++, line); ;
group.addFormInput(text2);

}

}
// check for text collapse
if ((prevGroup != null) && (group.onlyText && prevGroup.onlyText))
{

SBHtmlFormlabel txt = (SBHtmlFormLabel)prevGroup.GetAt(1);
SBHtmlFormLabel myGroup = (SBHtmlFormLabel)group.GetAt(1);
txt.Text = txt.Text + @“\n” + myGroup.Text;

}
else
{

if ((prevGroup != null) && (group.Type != prevGroup.Type))

group.Section = prevGroup.Section + 1;

form.addFormGroup(group);

}

}

Furthermore, those of ordinary skill in the art will recognize that the interface tools and methods illustrated above may be contained as a utility, program, subprogram, in any desired computer accessible medium. In addition, the interface tools and methods may be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer readable medium, which include storage devices and signals, in compressed or uncompressed form.

Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

FIG. 15 illustrates an exemplary block diagram of a computer system 1000 that may implement the interfaces and the methods shown in FIGS. 1-12. The computer system 1000 includes one or more processors, such as processor 1002, providing an execution platform for executing software. The processor 1002 may also execute an operating system (not shown) for executing the software in addition to performing operating system tasks.

The computer system 1000 also includes a main memory 1004, such as a Random Access Memory (RAM), providing storage for executing software during runtime and mass storage 1006. The mass storage 1006 may include a hard disk drive 1008 and/or a removable storage drive 1010, representing a floppy diskette drive, a magnetic tape drive, a compact disk drive, or a nonvolatile memory where a copy of software or data may be stored. Applications and resources may be stored in the mass memory 1006 and transferred to the main memory during run time. The mass memory 1006 may also include ROM (read only memory), EPROM (erasable, programmable ROM), EEPROM (electrically erasable, programmable ROM).

A user interfaces with the computer system 1000 with one or more input devices 1012, such as a keyboard, a mouse, a stylus, or any other input device and views results through a display 1014. A network interface 1016 is provided for communicating through a network 1018 with remote resources 1020. The remote resources 1020 may include servers, remote storage devices, data warehouses, or any other remote device capable of interacting with the computer system 1000.

What has been described and illustrated herein are examples of the systems and methods described herein along with some of their variations. The terms, descriptions and figures used herein are set forth by way of illustration only and are not meant as limitations. Those skilled in the art will recognize that many variations are possible within the spirit and scope of these examples, which intended to be defined by the following claims and their equivalents in which all terms are meant in their broadest reasonable sense unless otherwise indicated.

What is claimed is:

1. An interface tool for building a web page, the interface tool comprising:
a user interface comprising a design space, the user interface providing for a user to enter at least one text element in the design space; and
a parsing tool for translation of the at least one text element into at least one input object for the web page.

2. The interface tool of claim 1, wherein the web page is a web form.

3. The interface tool of claim 1, further comprising at least one report associated with data captured via the input object of the web page.

4. The interface tool of claim 1, further comprising at least one prescribed layout for the web page, wherein the layout is selectable by the user.

5. The interface tool of claim 4, wherein the user selects the layout from a plurality of prescribed layouts.

6. The interface tool of claim 1, wherein the layout is customizable by the user.

7. The interface tool of claim 1, wherein the input object is selected from the group consisting of a text box, a radio button, a check box and a drop-down box.

8. The interface tool of claim 1, further comprising a form library comprising at least one class that encapsulates at least one web page and its layout.

9. The interface tool of claim 1, further comprising a display for the web page in an internet browser.

10. The interface tool of claim 1, wherein the text element is selected from the group consisting of dashes, brackets and parentheses.

11. A method for building a web page using an interface tool, comprising:
providing a user interface comprising a design space;
a user entering at least one text element in the design space; and
parsing the text element into at least one input object for the web page.

12. The method of claim 11, wherein the web page is a web form.

13. The method of claim 12, further comprising providing at least one report for displaying data captured via the built web form.

14. The method of claim 11, further comprising providing at least one prescribed layout for the web page, wherein the layout is selectable by the user.

15. The method of claim 14, further comprising the user selecting the layout from a plurality of prescribed layouts.

16. The method of claim 11, further comprising providing at least one layout which is customizable by the user.

17. The method of claim 11, further comprising providing a form library comprising at least one web form and its layout.

18. The method of claim 11, further comprising displaying the built web page in an Internet browser.

19. A computer readable storage medium on which is embedded one or more computer programs, the one or more computer programs implementing a method for building a web page, the one or more computer programs comprising a set of instructions for:
providing a user interface comprising a design space, the user interface providing for a user to enter at least one text element in the design space; and
providing a parsing tool for translation of the at least one text element into at least one input object for the web page.

20. The computer readable storage medium of claim 19, wherein the web page is a web form.

21. The computer readable storage medium according to claim 19, said one or more computer programs further comprising a set of instructions for the translation of the at least one text element in the input object.

22. The computer readable storage medium according to claim 19, said one or more computer programs further comprising a set for instructions for creating a report for the displaying of data captured via the input object of the web page.

23. The computer readable storage medium according to claim 19, said one or more computer programs further comprising a set of instructions directing the creation of a report for the displaying of data captured via the input object of a web page.

24. The computer readable storage medium according to claim 19, said one or more computer programs further comprising a set of instructions directing the user to build the web page.

25. The computer readable storage medium according to claim 19, said one or more computer programs further comprising a set of instructions directing the user to display the web page in an Internet browser.

26. The computer readable storage medium according to claim 19, said one or more computer programs further comprising a set of instructions for providing at least one layout which is customizable by the user.
